(19) United States
(12) Patent Application Publication
(10) Pub. No.: US 2026/0045732 A1
(43) Pub. Date: Feb. 12, 2026

(54) DC SOCKET

(71) Applicant: Schneider Electric Industries SAS, Rueil Malmaison (FR)

(72) Inventor: Youliang ZHANG, Shenzhen (CN)

(21) Appl. No.: 19/290,897

(22) Filed: Aug. 5, 2025

(30) Foreign Application Priority Data
Aug. 12, 2024 (CN) 202411104634.1

(51) Int. Cl. H01R 13/53; H01R 13/11; H01R 103/00

(52) U.S. Cl. CPC H01R 13/53; H01R 13/113; H01R 2103/00

(57) ABSTRACT

A DC socket is provided and includes: a housing; a positive wiring assembly including a terminal segment and a plug-in sleeve segment separated from each other; a moving contact assembly rotatable relative to the housing to switch between a switching-on position and a switching-off position; a switch assembly including an actuating member, a locking member, and a transmission member; and a reset member. During a process of the plug being pulled out from the DC socket, the actuating member can rotate relative to the housing when released from being limited by the ground pin, the locking member can rotate to a position for releasing the moving contact assembly, the reset member drives the moving contact assembly to the switching-off position, and the moving contact assembly is separated from the terminal segment and the plug-in sleeve segment before a positive pin of the plug is disengaged from the plug-in sleeve segment.

### CROSS-REFERENCE

This application claims priority to Chinese Patent Application No. 202411104634.1, filed on Aug. 12, 2024, and entitled “DC SOCKET”, the entirety of which is incorporated herein by reference.

### FIELD

Embodiments of the present disclosure generally relate to the technical field of electrical equipment, and more particularly, to a DC socket.

### BACKGROUND

A direct-current socket (DC socket) is an electrical socket for connecting a DC power supply. Since the direct current (DC) does not change periodically, that is, the DC does not have zero-crossing point, during a process of plugging in and pulling out a plug, an arc between the plug and the socket burns for a long time, thereby damaging the plug and the socket.

Therefore, how to avoid arc generation between the plug and the socket is a technical problem that the current DC socket needs to be solved.

### SUMMARY

In an aspect of the present disclosure, a DC socket is provided. The DC socket includes: a housing; a positive wiring assembly disposed on the housing and including a terminal segment and a plug-in sleeve segment separated from each other; a moving contact assembly disposed on the housing and rotatable relative to the housing to switch between a switching-on position and a switching-off position, the moving contact assembly being connected to the terminal segment and the plug-in sleeve segment at the switching-on position, the moving contact assembly being separated from the terminal segment and the plug-in sleeve segment at the switching-off position; a switch assembly disposed on the housing and including an actuating member, a locking member, and a transmission member connected between the actuating member and the locking member; and a reset member disposed between the housing and the moving contact assembly. when a plug is inserted into the DC socket, the actuating member is driven and limited by a ground pin of the plug, the reset member is compressed, and the moving contact assembly is locked to the switching-on position by the locking member. During a process of the plug being pulled out from the DC socket, the actuating member is adapted to rotate relative to the housing when released from being limited by the ground pin, the locking member is adapted to rotate to a position for releasing the moving contact assembly under the driving of the actuating member, the reset member drives the moving contact assembly to the switching-off position, and the moving contact assembly is separated from the terminal segment and the plug-in sleeve segment before a positive pin of the plug is disengaged from the plug-in sleeve segment, so that an electrical connection between the terminal segment and the plug-in sleeve segment is cut off.

In some embodiments, during a process of the plug being inserted into the DC socket, the moving contact assembly contacts the terminal segment and the plug-in sleeve segment after the positive pin of the plug contacts the plug-in sleeve segment, so that the terminal segment is electrically connected to the plug-in sleeve segment.

In some embodiments, the moving contact assembly includes a conducting member provided with a pair of moving contact points, one moving contact point of the pair of moving contacts points is mated with the terminal segment, and the other moving contact point of the pair of moving contact points is mated with the plug-in sleeve segment.

In some embodiments, the moving contact assembly further includes an insulating member connected to the conducting member, the insulating member includes a mating surface and a pair of first rotating portions, and the pair of first rotating portions is rotatably connected to the housing, and during a process of the ground pin being inserted into the DC socket and pressing the mating surface, the ground pin drives the moving contact assembly to the switching-on position, and the reset member is gradually compressed.

In some embodiments, the actuating member includes a first body portion, a protruding portion, a first elastic member, a limiting shaft and a pair of second rotating portions, the protruding portion is disposed on a side of the first body portion facing the locking member, the first elastic member is disposed between the housing and a side of the first body portion facing away from the locking member, one end of the first body portion is connected to the transmission member via the limiting shaft, and the pair of second rotating portions is disposed at the other end of the first body portion and is rotatably connected to the housing, and when the ground pin is inserted into the DC socket and drives the protruding portion, the first body portion is adapted to rotate relative to the housing and gradually compress the first elastic portion, and the first body portion is adapted to drive the transmission portion to move.

In some embodiments, the mating surface is spaced apart from the protruding portion, and the mating surface is closer to the reset member than the protruding portion, and the ground pin presses the mating surface after driving the protruding portion.

In some embodiments, the transmission member includes a second body portion and a pair of moving portions, a first end of the second body portion is connected to the first body portion via the limiting shaft, the pair of moving portions is disposed on a second end of the second body portion, the locking member includes a third body portion, one end of the third body portion clamps the second body portion and includes a pair of receiving holes, and each of the pair of moving portions is disposed in a corresponding receiving hole, and during a process of the first body portion rotating and gradually compressing the first elastic member, the insulating member blocks the locking member from rotating, and each of the pair of moving portions is adapted to move within the corresponding receiving hole.

In some embodiments, the transmission member further includes a second elastic member, one end of the second elastic member is disposed on the second end of the second body portion, and the other end of the second elastic member is disposed on the locking member, and during the process of the first body portion rotating and gradually compressing the first elastic member, the second body portion is adapted to move under the driving of the first body portion and gradually compress the second elastic member.

In some embodiments, the third body portion includes a first side surface facing the actuating member, when the moving contact assembly is at the switching-off position, the insulating member contacts the first side surface to block the locking member from rotating, and during the process of the ground pin being inserted into the DC socket and pressing the mating surface, the insulating member is adapted to rotate to a position offset from the first side surface.

In some embodiments, the third body portion further includes a second side surface facing the actuating member and a connecting surface located between the first side surface and the second side surface, and the first side surface is closer to the actuating member than the second side surface, and when the insulating member rotates to the position offset from the first side surface, the second elastic member drives the third body portion towards the actuating member until the connecting surface contacts the insulating member, so that the locking member locks the moving contact assembly to the switching-on position.

It should be understood that content described in this content section is not intended to limit key features or important features of embodiments of the present disclosure, nor is it intended to limit the scope of the present disclosure. Other features of the present disclosure will be readily understood from the following description.

### BRIEF DESCRIPTION OF DRAWINGS

The above and other features, advantages, and aspects of embodiments of the present disclosure will become more apparent with reference to the following detailed description taken in conjunction with the accompanying drawings. In the drawings, the same or similar reference numbers refer to the same or similar elements, wherein:

FIG. 1 shows a schematic structural diagram of a DC socket according to some embodiments of the present disclosure;

FIG. 2 shows a schematic structural diagram of a moving contact assembly and a reset member according to some embodiments of the present disclosure;

FIG. 3 shows a schematic structural diagram of a switch assembly according to some embodiments of the present disclosure;

FIG. 4 shows a cross-sectional view of the switch assembly shown in FIG. 3;

FIGS. 5 to 10 show schematic diagrams of a process of switching a moving contact assembly from a switching-off position to a switching-on position according to some embodiments of the present disclosure; and

FIGS. 11 to 13 show schematic diagrams of a process of switching a moving contact assembly to a switching-off position according to some embodiments of the present disclosure.

### DESCRIPTION OF REFERENCE NUMERALS

100 DC socket; 200 plug, 201 ground pin, 202 positive pin;
1 housing;
2 positive wiring assembly, 21 terminal segment, 22 plug-in sleeve segment;
3 moving contact assembly, 31 insulating member, 311 mating surface, 312 first rotating portion, 32 conducting member, 33 moving contact point;
4 switch assembly, 41 actuating member, 411 first body portion, 412 protruding portion, 413 first elastic member, 414 limiting shaft, 415 second rotating portion, 42 transmission member, 421 second body portion, 422 moving portion, 423 second elastic member, 43 locking member, 431 third body portion, 4311 receiving hole, 4312 first side surface, 4313 second side surface, 4314 connecting surface, 432 third rotating portion;
5 reset member; 6 negative wiring assembly; 7 ground wiring assembly.

### DETAILED DESCRIPTION

Embodiments of the present disclosure will be described in more detail below with reference to the accompanying drawings. Although the embodiments of the present disclosure are shown in the drawings, it should be understood that the present disclosure may be implemented in various forms and should not be limited by embodiments set forth herein. Rather, these embodiments are provided to make the present disclosure more thorough and complete, and can fully convey the scope of the present disclosure to those skilled in the art.

As used herein, the term “including” and variations thereof means open inclusive, i.e., “including but not limited to”. Unless specifically stated, the term “or” means “and/or”. The term “based on” means “based at least in part on”. The terms “an example embodiment” and “an embodiment” mean “at least one example embodiment”. The term “another embodiment” means “at least one further embodiment”. The terms “first”, “second”, and the like may refer to different or identical objects.

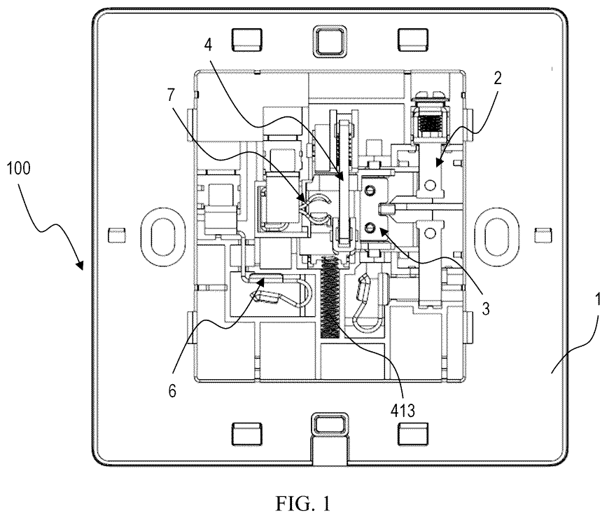

As described above, since the DC socket does not have zero-crossing point, during a process of plugging in and pulling out a plug, an arc between the plug and the socket burns for a long time, thereby damaging the plug and the socket. Based on this, embodiments of the present disclosure provide a DC socket 100 to at least partially solve the above problems. Hereinafter, the principles of the present disclosure will be described with reference to FIGS. 1 to 13.

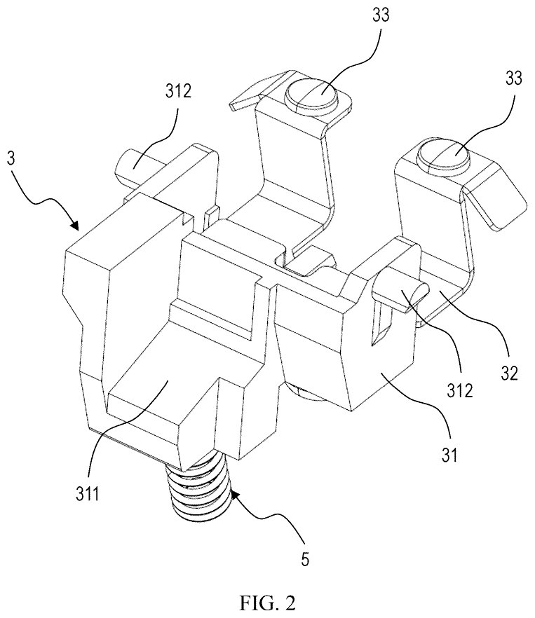

FIG. 1 shows a schematic structural diagram of a DC socket 100 according to some embodiments of the present disclosure. FIG. 2 shows a schematic structural diagram of a moving contact assembly 3 and a reset member 5 according to some embodiments of the present disclosure. As shown in FIGS. 1 to 2, the DC socket 100 described herein generally includes a housing 1, a positive wiring assembly 2, a moving contact assembly 3, a switch assembly 4, a reset member 5, a negative wiring assembly 6, and a ground wiring assembly 7. The positive wiring assembly 2, the negative wiring assembly 6, and the ground wiring assembly 7 are respectively disposed on the housing 1. The plug 200 can be inserted into or pulled out from the DC socket 100. The positive pin 202 can mate with the positive wiring assembly 2, the negative pin (not shown) can mate with the negative wiring assembly 6, and the ground pin 201 can mate with the ground wiring assembly 7. Apparently, when the positive pin 202 contacts or is disengaged from the positive wiring assembly 2, the negative pin should contact or be disengaged from the negative wiring assembly 6.

With continued reference to FIGS. 1 to 2, the moving contact assembly 3 is disposed on the housing 1, and the moving contact assembly 3 is rotatable relative to the housing 1 towards or away from the positive wiring assembly 2, so as to switch between a switching-off position and a switching-on position.

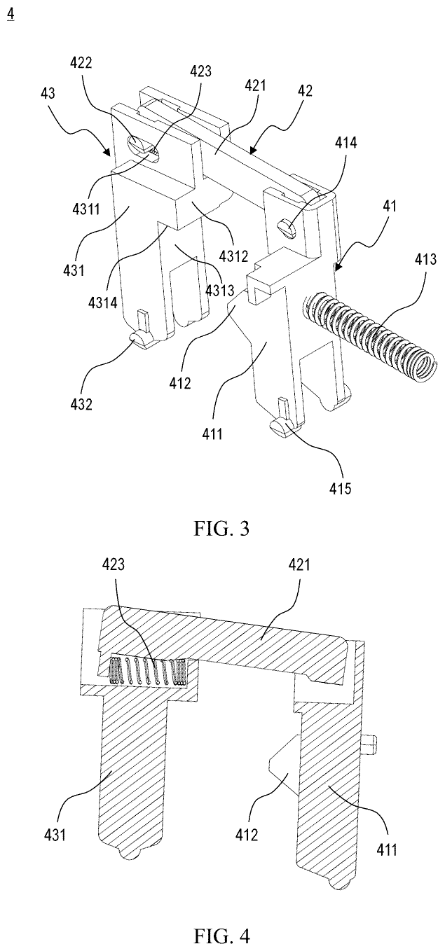

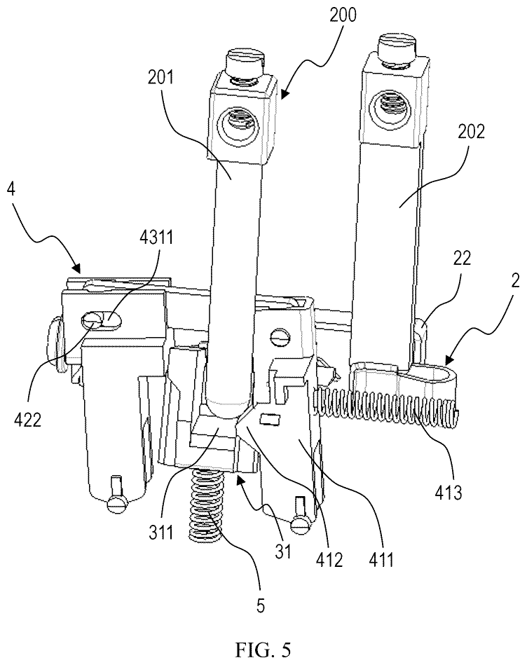

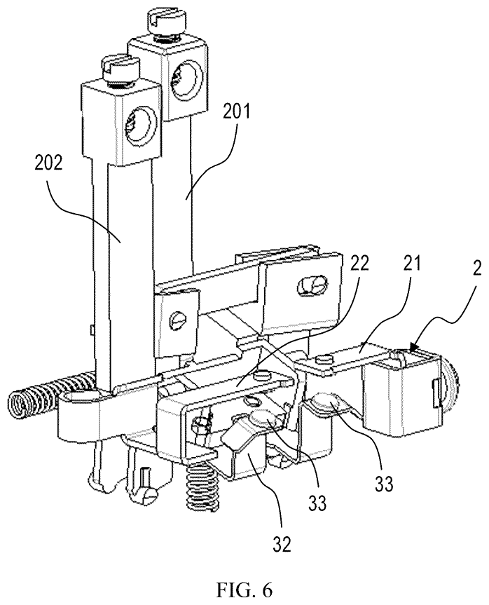

FIG. 3 shows a schematic structural diagram of a switch assembly 4 according to some embodiments of the present disclosure. FIG. 4 shows a cross-sectional view of the switch assembly 4 shown in FIG. 3. FIGS. 5 to 10 show schematic diagrams of a process of switching the moving contact assembly 3 from the switching-off position to the switching-on position according to some embodiments of the present disclosure. As shown in FIGS. 5 to 6, the positive wiring assembly 2 includes a terminal segment 21 and a plug-in sleeve segment 22, and the terminal segment 21 and the plug-in sleeve segment 22 are separated from each other.

With continued reference to FIGS. 2, 5 and 6, the moving contact assembly 3 is at the switching-off position. When the moving contact assembly 3 is at the switching-off position, the moving contact assembly 3 is separated from the terminal segment 21 and the plug-in sleeve segment 22, respectively, so that the terminal segment 21 and the plug-in sleeve segment 22 are not conducted with each other. With continued reference to FIGS. 2, 9 and 10, the moving contact assembly 3 is at the switching-on position. When the moving contact assembly 3 is at the switching-on position, the moving contact assembly 3 is connected to the terminal segment 21 and the plug-in sleeve segment 22, respectively, so that the terminal segment 21 and the plug-in sleeve segment 22 can be conducted with each other via the moving contact assembly 3. More specifically, the terminal segment 21 and the plug-in sleeve segment 22 are conducted with each other via the conducting member 32.

As shown in FIGS. 1, 3 and 4, the switch assembly 4 is disposed on the housing 1. The switch assembly 4 includes an actuating member 41, a locking member 43, and a transmission member 42. The transmission member 42 is connected between the actuating member 41 and the locking member 43. With continued reference to FIGS. 1 to 2, the reset member 5 is disposed between the housing 1 and the moving contact assembly 3, and the reset member 5 can be deformed under a force applied thereto.

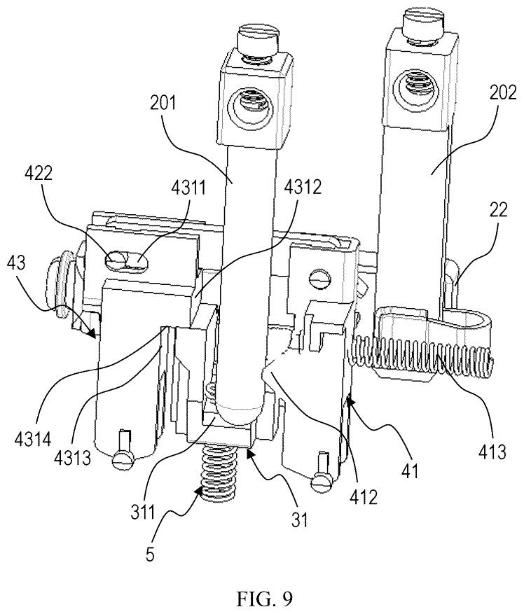

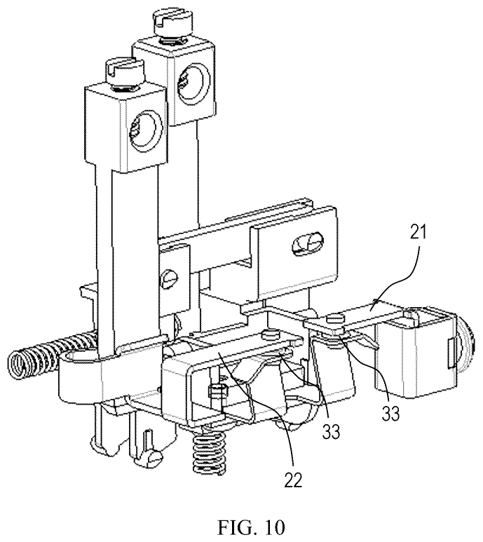

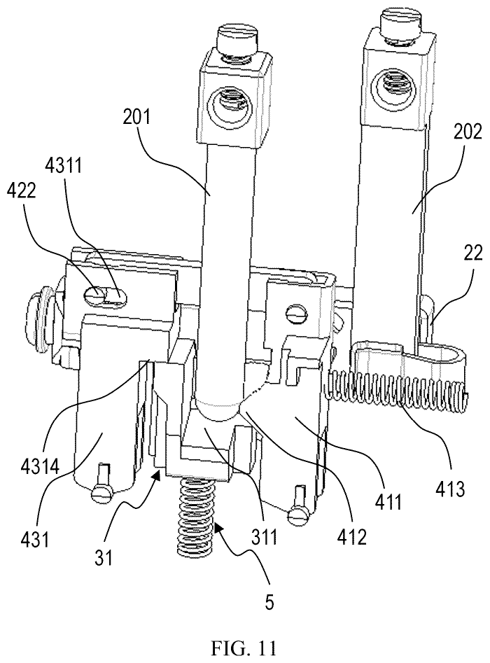

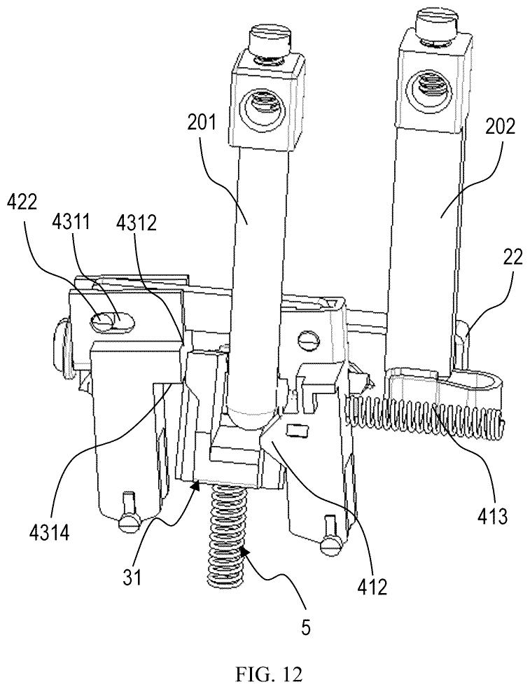

FIGS. 11 to 13 show schematic diagrams of a process of switching the moving contact assembly 3 to the switching-off position according to some embodiments of the present disclosure. Referring to FIGS. 9 to 10, when the plug 200 is inserted into the DC socket 100, the actuating member 41 is driven and limited by the ground pin 201, the reset member 5 is compressed, and the moving contact assembly 3 is locked to the switching-on position by the locking member 43. With continued reference to FIGS. 11 to 13, during a process of the plug 200 being pulled out from the DC socket 100, the actuating member 41 can rotate relative to the housing 1 when released from being limited by the ground pin 201, the locking member 43 can rotate to a position for releasing the moving contact assembly 3 under the driving of the actuating member 41, and the reset member 5 drives the moving contact assembly 3 to the switching-off position. With continued reference to FIG. 12, the moving contact assembly 3 can be separated from the terminal segment 21 and the plug-in sleeve segment 22 before the positive pin 202 of the plug 200 is disengaged from the plug-in sleeve segment 22, so that an electrical connection between the terminal segment 21 and the plug-in sleeve segment 22 is cut off.

It can be understood that, during the process of the plug 200 being pulled out from the DC socket 100, before the positive pin 202 is disengaged from the plug-in sleeve segment 22, the moving contact assembly 3 has been separated from the positive wiring assembly 2, then the plug 200 can be pulled out when the DC socket 100 is not energized, thereby avoiding arc generation between the plug 200 and the DC socket 100.

However, the inventors have noted that even when the plug 200 is pulled out while the DC socket 100 is not energized, there is still a risk of arc generation between the plug 200 and the DC socket 100. This is due to the characteristic of the DC socket 100 that it does not have zero-crossing point, which results in a long time of arc burning. Even though the moving contact assembly 3 has been separated from the positive wiring assembly 2 before the positive pin 202 is disengaged from the plug-in sleeve segment 22, there is still a risk of arc generation between the plug 200 and the DC socket 100 if the arc burning time between the moving contact assembly 3 and the positive wiring assembly 2 is long and the arc is still not extinguished when the positive pin 202 is disengaged from the plug-in sleeve segment 22.

According to embodiments of the present disclosure, when the moving contact assembly 3 is at the switching-on position, the moving contact assembly 3 is locked by the locking member 43 and cannot rotate, so that before the locking member 43 rotates to the position for releasing the moving contact assembly 3, the moving contact assembly 3 is always locked to the switching-on position by the locking member 43, and the terminal segment 21 and the plug-in sleeve segment 22 are conducted with each other via the conducting member 32. During the process of the plug 200 being pulled out, when the actuating member 41 is just released from being limited by the ground pin 201, the locking member 43 can rotate to the position for releasing the moving contact assembly 3 under the driving of the actuating member 41, and the reset member 5 can release energy and quickly drive the moving contact assembly 3 to rotate away from the positive wiring assembly 2 quickly, thereby quickly extinguishing the arc between the moving contact assembly 3 and the positive wiring assembly 2. Further, since the arc between the moving contact assembly 3 and the positive wiring assembly 2 can be quickly extinguished, and the moving contact assembly 3 is separated from the positive wiring assembly 2 before the positive pin 202 of the plug 200 is disengaged from the plug-in sleeve segment 22, the arc between the plug 200 and the DC socket 100 can be further prevented from being generated.

In addition, since the arc between the moving contact assembly 3 and the positive wiring assembly 2 can be quickly extinguished, an contact point of the moving contact assembly 3 and an contact point of the positive wiring assembly 2 can be prevented from being severely worn, and the plastic around the contact points can also be prevented from being severely ablated. In addition, during a process of switching the moving contact assembly 3 to the switching-off position, whether the moving contact assembly 3 rotates is related to whether the ground pin 201 is at the position for releasing limitation, rather than the speed at which the plug 200 is pulled out, and therefore, even if the plug 200 is pulled out slowly, the moving contact assembly 3 can rotate quickly away from the positive wiring assembly 2, thereby avoiding the problem of long time of arc burning between the moving contact assembly 3 and the positive wiring assembly 2 due to slow rotation of the moving contact assembly 3 away from the positive wiring assembly 2 caused by slowly pulling out the plug 200.

Referring to FIGS. 5 to 6, in some embodiments, during the process of the plug 200 being inserted into the DC socket 100, the moving contact assembly 3 does not contact the terminal segment 21 and the plug-in sleeve segment 22 when the positive pin 202 contacts the plug-in sleeve segment 22. It can be understood that, during the process of the plug 200 being inserted into the DC socket 100, the moving contact assembly 3 contacts the terminal segment 21 and the plug-in sleeve segment 22 after the positive pin 202 contacts the plug-in sleeve segment 22, so that the terminal segment 21 is electrically connected to the plug-in sleeve segment 22. Therefore, the plug 200 can be inserted into the DC socket 100 while the DC socket 100 is not energized, thereby avoiding arc generation between the plug 200 and the DC socket 100.

Referring back to FIG. 2, in some embodiments, a pair of moving contact points 33 are disposed on the conducting member 32. One moving contact point 33 of the pair of moving contact points 33 is mated with the terminal segment 21, and the other moving contact point 33 of the pair of moving contact points 33 is mated with the plug-in sleeve segment 22. Therefore, on the premise that the stroke of the moving contact assembly 3 is not changed, the electrical clearance of the DC socket 100 is significantly increased, so that the arc between the moving contact assembly 3 and the positive wiring assembly 2 can be quickly extinguished, and then the arc generation between the plug 200 and the DC socket 100 is avoided.

Referring back to FIG. 2, in some embodiments, the moving contact assembly 3 may further include an insulating member 31, and the conducting member 32 may be disposed on the insulating member 31. The insulating member 31 may include a mating surface 311 and a pair of first rotating portions 312. The pair of first rotating portions 312 is rotatably connected to the housing 1, so that the moving contact assembly 3 can rotate relative to the housing 1 towards or away from the positive wiring assembly 2. The mating surface 311 and the pair of moving contact points 33 may be disposed on two sides or the same side of the pair of first rotating portions 312, so that when the mating surface 311 is pressed downward by the ground pin 201, the pair of moving contact points 33 can rotate upward towards the positive wiring assembly 2.

In some embodiments, the mating surface 311 may be a mating plane. In some other embodiments, the mating surface 311 may be a mating curved surface, which is not limited herein.

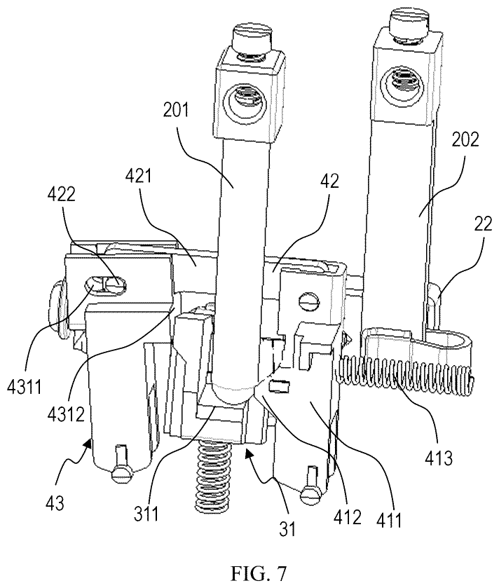

With continued reference to FIGS. 7 to 10, in this embodiment, during a process of the ground pin 201 being inserted into the DC socket 100 and pressing the mating surface 311, the ground pin 201 drives the moving contact assembly 3 to the switching-on position, and the reset member 5 is gradually compressed.

Referring back to FIGS. 3 to 4, in some embodiments, the actuating member 41 may include a first body portion 411, a protruding portion 412, a first elastic member 413, a limiting shaft 414, and a pair of second rotating portions 415. The protruding portion 412 may be disposed on a side of the first body portion 411 facing the locking member 43 for interacting with the ground pin 201. The first elastic member 413 is disposed between the housing 1 and a side of the first body portion 411 facing away from the locking member 43. One end of the first body portion 411 is connected to the transmission member 42 via the limiting shaft 414, and the pair of second rotating portion 415 is disposed at the other end of the first body portion 411 and is rotatably connected to the housing 1.

With continued reference to FIGS. 5 and 7, in this embodiment, when the ground pin 201 is inserted into the DC socket 100 and drives the protruding portion 412, the first body portion 411 can rotate relative to the housing 1 and gradually compress the first elastic member 413, and the first body portion 411 can drive the transmission member 42 to move.

With continued reference to FIGS. 5 and 7, in some embodiments, when the moving contact assembly 3 is at the switching-off position, the mating surface 311 is spaced apart from the protruding portion 412, and the mating surface 311 is closer to the reset member 5 than the protruding portion 412. Thus, on one hand, the ground pin 201 can press the mating surface 311 only after driving the protruding portion 412. On the other hand, referring to FIGS. 9 and 11, during the process of the moving contact assembly 3 rotating relative to the housing 1 under the driving of the reset member 5, the insulating member 31 and the protruding portion 412 are prevented from interfering with each other.

Referring back to FIGS. 3 to 4, in some embodiments, the transmission member 42 may include a second body portion 421 and a pair of moving portions 422. A first end of the second body portion 421 is connected to the first body portion 411 via the limiting shaft 414, and the pair of moving portions 422 is disposed on a second end of the second body portion 421. One moving portion 422 of the pair of moving portions 422 may be disposed on one side of the second body portion 421, and the other moving portion 422 of the pair of moving portions 422 may be disposed on an opposite side of the second body portion 421. Correspondingly, the locking member 43 may include a third body portion 431 and a pair of third rotating portions 432. One end of the third body portion 431 clamps the second body portion 421 and includes receiving holes 4311. Each of the pair of moving portions 422 is disposed in a corresponding receiving hole 4311. The pair of third rotating portions 432 may be rotatably connected to the housing 1 to enable the locking member 43 to rotate relative to the housing 1.

Referring to FIGS. 5 and 7, in this embodiment, during a process of the first body portion 411 rotating and gradually compressing the first elastic member 413, since the insulating member 31 blocks the locking member 43 from rotating and the locking member 43 cannot rotate, the actuating member 41 and the transmission member 42 need to move, so that each of the pair of moving portions 422 is movable within the corresponding receiving hole 4311, thereby preventing the mechanism from being stuck. Further, referring to FIG. 5, the moving portion 422 is located at the left portion of the receiving hole 4311. Referring to FIG. 7, the moving portion 422 moves to the right portion of the receiving hole 4311.

Referring back to FIGS. 3 to 4, in some embodiments, the transmission member 42 may further include a second elastic member 423. One end of the second elastic member 423 may be disposed on the second end of the second body portion 421. The other end of the second elastic member 423 may be disposed on the third body portion 431 of the locking member 43.

With continued reference to FIGS. 4, 5 and 7, in this embodiment, during the process of the first body portion 411 rotating and gradually compressing the first elastic member 413, the second body portion 421 can move under the driving of the first body portion 411, and since the third body portion 431 is blocked by the insulating member 31 and cannot rotate, the second body portion 421 gradually compresses the second elastic member 423. It can be understood that the compressed second elastic member 423 can store energy, referring to FIGS. 7 and 9, when the insulating member 31 rotates to a position offset from the third body portion 431, the second elastic member 423 can release energy and drive the third body portion 431 to rotate towards the actuating member 41.

Further, referring to FIG. 7, the moving portion 422 is located at the right portion of the receiving hole 4311. Referring to FIGS. 9 and 11, the moving portion 422 is located at the left portion of the receiving hole 4311. That is, when the moving contact assembly 3 is at the switching-on position, since the moving portion 422 is located at the left portion of the receiving hole 4311, the actuating member 41 can rotate relative to the housing 1 under the driving of the first elastic member 413 when the actuating member 41 is released from being limited by the ground pin 201, so that the locking member 43 can rotate under the driving of the actuating member 41 and the transmission member 42.

Referring to FIG. 3, in some embodiments, the third body portion 431 may include a first side surface 4312, a second side surface 4313, and a connecting surface 4314. The first side surface 4312 may face the actuating member 41, the second side surface 4313 may face the actuating member 41, and the first side surface 4312 is closer to the actuating member 41 than the second side surface 4313. The connecting surface 4314 may be located between the first side surface 4312 and the second side surface 4313.

Referring to FIGS. 5 and 7, when the moving contact assembly 3 is at the switching-off position, the insulating member 31 contacts the first side surface 4312 to block the locking member 43 from rotating. Referring to FIGS. 7 and 9, during the process of the ground pin 201 being inserted into the DC socket 100 and pressing the mating surface 311, the insulating member 31 can rotate to the position offset from the first side surface 4312. When the insulating member 31 rotates to the position offset from the first side surface 4312, the second elastic member 423 can drive the third body portion 431 towards the actuating member 41 until the connecting surface 4314 contacts the insulating member 31, and the insulating member 31 is locked by the locking member 43 and cannot rotate, so that the locking member 43 locks the moving contact assembly 3 to the switching-on position.

The process of switching the moving contact assembly 3 from the switching-off position to the switching-on position will be described below with reference to FIGS. 5 to 10.

Referring to FIGS. 5 to 6, the plug 200 is being inserted, the ground pin 201 does not drive the protruding portion 412, and the ground pin 201 does not press the mating surface 311. The moving contact assembly 3 is at the switching-off position under the action of the reset member 5. At the same time, the positive pin 202 has been in contact with the plug-in sleeve segment 22, and the negative pin has been in contact with the negative wiring component 6.

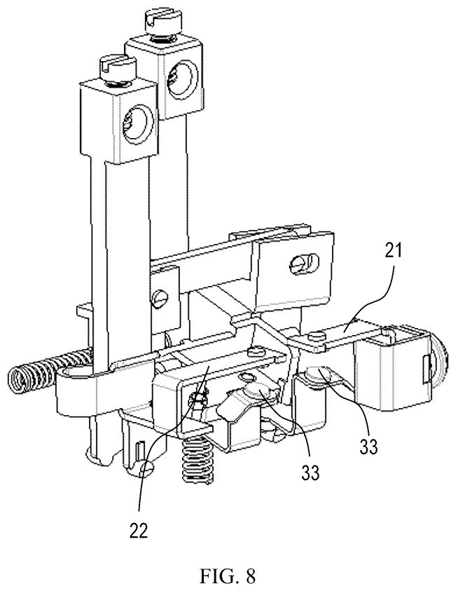

With continued reference to FIGS. 7 to 8, the plug 200 continues to be inserted, the ground pin 201 drives the protruding portion 412, the first body portion 411 rotates relative to the housing 1, and the first elastic member 413 is gradually compressed. At the same time, the first body portion 411 can drive the transmission member 42 to move, and since the locking member 43 is blocked by the insulating member 31 and cannot rotate, the moving portion 422 moves from a position at the left portion of the receiving hole 4311 to a position at the right portion of the receiving hole 4311. The second body portion 421 gradually compresses the second elastic member 423. Since the ground pin 201 does not press the mating surface 311, the moving contact assembly 3 is still at the switching-off position and the reset member 5 is not compressed.

With continued reference to FIGS. 9 to 10, the plug 200 continues to be inserted, the ground pin 201 presses the mating surface 311, the moving contact assembly 3 rotates to the switching-on position, and the reset member 5 is gradually compressed. If the insulating member 31 of the moving contact assembly 3 rotates to the position offset from the first side surface 4312 of the locking member 43, the second elastic member 423 can release energy and drive the locking member 43 to rotate towards the actuating member 41. When the connecting surface 4314 of the locking member 43 rotates to the position where it contacts the insulating member 31, the locking member 43 locks the moving contact assembly 3 to the switching-on position, and the actuating member 41 is limited by the ground pin 201 and cannot rotate.

The process of switching the moving contact assembly 3 from the switching-on position to the switching-off position will be described below with reference to FIGS. 9 to 13.

Referring to FIGS. 9 to 10, the plug 200 is not pulled out, the actuating member 41 is limited by the ground pin 201, the first elastic member 413 is compressed, and the moving contact assembly 3 is locked to the switching-on position by the locking member 43. The reset member 5 is also compressed.

Referring to FIG. 11, the plug 200 is being pulled out, the ground pin 201 is gradually separated from the moving contact assembly 3, but the actuating member 41 is still limited by the ground pin 201, and the first elastic member 413 is still compressed. Since the locking member 43 does not rotate, the moving contact assembly 3 is still locked to the switching-on position by the locking member 43. The reset member 5 is still compressed.

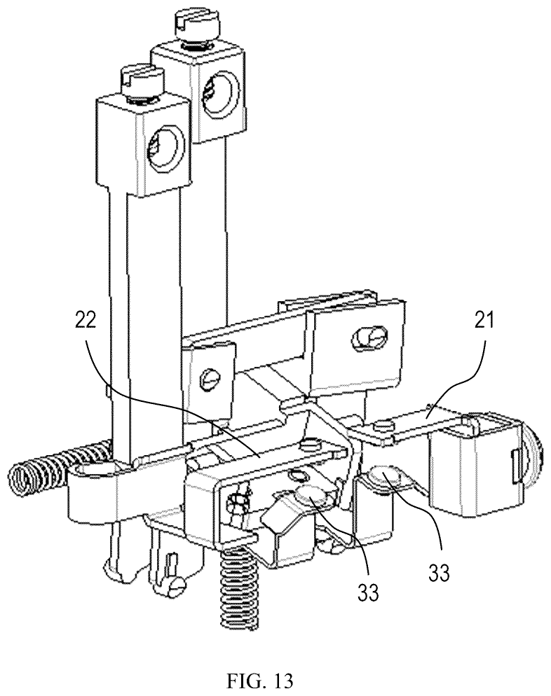

Referring to FIGS. 12 to 13, the plug 200 continues to be pulled out, the actuating member 41 is released from being limited by the ground pin 201, the first elastic member 413 releases energy and drives the actuating member 41 to rotate relative to the housing 1. The locking member 43 can rotate to the position for releasing the moving contact assembly 3 under the driving of the actuating member 41 and the transmission member 42. The reset member 5 releases energy and drives the moving contact assembly 3 to the switching-off position, and the insulating member 31 of the moving contact assembly 3 rotates to the position where it contacts the first side surface 4312. When the moving contact assembly 3 is at the switching-off position, the positive pin 202 is not separated from the plug-in sleeve segment 22, and the negative pin is not separated from the negative wiring assembly 6.

According to embodiments of the present disclosure, when the moving contact assembly is at the switching-on position, the moving contact assembly is locked by the locking member and cannot rotate, so that before the locking member rotates to the position for releasing the moving contact assembly, the moving contact assembly is always locked to the switching-on position by the locking member, and the terminal segment and the plug-in sleeve segment are conducted with each other via the conducting member. During the process of the plug being pulled out, when the actuating member is just released from being limited by the ground pin, the locking member is adapted to rotate to the position for releasing the moving contact assembly under the driving of the actuating member, and the reset member can release energy and quickly drive the moving contact assembly to rotate away from the positive wiring assembly quickly, thereby quickly extinguishing an arc between the moving contact assembly and the positive wiring assembly. Further, since the arc between the moving contact assembly and the positive wiring assembly can be quickly extinguished, and the moving contact assembly is separated from the positive wiring assembly before the positive pin is disengaged from the plug-in sleeve segment, an arc between the plug and the DC socket can be further prevented from being generated.

The arc extinguishing design according to embodiments of the present disclosure may be applied to various DC socket 100 to at least partially solve the above problems. It should be understood that the arc extinguishing design according to embodiments of the present disclosure may also be applied to other electrical components, which is not limited in embodiments of the present disclosure.

Embodiments of the present disclosure have been described above, and the above description is illustrative, not exhaustive, and is not limited to the disclosed embodiments. Many modifications and variations will be apparent to those of ordinary skill in the art without departing from the scope and spirit of the illustrated embodiments. The selection of terms as used herein is intended to best explain the principles of the embodiments, the practical application or technical improvements to the market, or to enable others of ordinary skill in the art to understand the embodiments disclosed herein.

1. A DC socket, comprising:
a housing;
a positive wiring assembly disposed on the housing and including a terminal segment and a plug-in sleeve segment separated from each other;
a moving contact assembly disposed on the housing and rotatable relative to the housing to switch between a switching-on position and a switching-off position, the moving contact assembly being connected to the terminal segment and the plug-in sleeve segment at the switching-on position, the moving contact assembly being separated from the terminal segment and the plug-in sleeve segment at the switching-off position;
a switch assembly disposed on the housing and comprising an actuating member, a locking member, and a transmission member connected between the actuating member and the locking member; and
a reset member disposed between the housing and the moving contact assembly,
wherein when a plug is inserted into the DC socket, the actuating member is driven and limited by a ground pin of the plug, the reset member is compressed, and the moving contact assembly is locked to the switching-on position by the locking member, and
wherein during a process of the plug being pulled out from the DC socket, the actuating member is adapted to rotate relative to the housing when released from being limited by the ground pin, the locking member is adapted to rotate to a position for releasing the moving contact assembly under the driving of the actuating member, the reset member drives the moving contact assembly to the switching-off position, and the moving contact assembly is separated from the terminal segment and the plug-in sleeve segment before a positive pin of the plug is disengaged from the plug-in sleeve segment, so that an electrical connection between the terminal segment and the plug-in sleeve segment is cut off.

2. The DC socket according to claim 1, wherein during a process of the plug being inserted into the DC socket, the moving contact assembly contacts the terminal segment and the plug-in sleeve segment after the positive pin of the plug contacts the plug-in sleeve segment, so that the terminal segment is electrically connected to the plug-in sleeve segment.

3. The DC socket according to claim 1, wherein the moving contact assembly comprises a conducting member provided with a pair of moving contact points, one moving contact point of the pair of moving contacts points is mated with the terminal segment, and the other moving contact point of the pair of moving contact points is mated with the plug-in sleeve segment.

4. The DC socket according to claim 3, wherein the moving contact assembly further comprises an insulating member connected to the conducting member, the insulating member comprises a mating surface and a pair of first rotating portions, and the pair of first rotating portions is rotatably connected to the housing, and
wherein during a process of the ground pin being inserted into the DC socket and pressing the mating surface, the ground pin drives the moving contact assembly to the switching-on position, and the reset member is gradually compressed.

5. The DC socket according to claim 4, wherein the actuating member comprises a first body portion, a protruding portion, a first elastic member, a limiting shaft and a pair of second rotating portions, the protruding portion is disposed on a side of the first body portion facing the locking member, the first elastic member is disposed between the housing and a side of the first body portion facing away from the locking member, one end of the first body portion is connected to the transmission member via the limiting shaft, and the pair of second rotating portions is disposed at the other end of the first body portion and is rotatably connected to the housing, and
wherein when the ground pin is inserted into the DC socket and drives the protruding portion, the first body portion is adapted to rotate relative to the housing and gradually compress the first elastic portion, and the first body portion is adapted to drive the transmission portion to move.

6. The DC socket according to claim 5, wherein the mating surface is spaced apart from the protruding portion, and the mating surface is closer to the reset member than the protruding portion, and
wherein the ground pin presses the mating surface after driving the protruding portion.

7. The DC socket according to claim 5, wherein the transmission member comprises a second body portion and a pair of moving portions, a first end of the second body portion is connected to the first body portion via the limiting shaft, the pair of moving portions is disposed on a second end of the second body portion, the locking member comprises a third body portion, one end of the third body portion clamps the second body portion and comprises a pair of receiving holes, and each of the pair of moving portions is disposed in a corresponding receiving hole, and
wherein during a process of the first body portion rotating and gradually compressing the first elastic member, the insulating member blocks the locking member from rotating, and each of the pair of moving portions is adapted to move within the corresponding receiving hole.

8. The DC socket according to claim 7, wherein the transmission member further comprises a second elastic member, one end of the second elastic member is disposed on the second end of the second body portion, and the other end of the second elastic member is disposed on the locking member, and
wherein during the process of the first body portion rotating and gradually compressing the first elastic member (413), the second body portion is adapted to move under the driving of the first body portion and gradually compress the second elastic member.

9. The DC socket according to claim 8, wherein the third body portion comprises a first side surface facing the actuating member,
wherein when the moving contact assembly is at the switching-off position, the insulating member contacts the first side surface to block the locking member from rotating, and
wherein during the process of the ground pin being inserted into the DC socket and pressing the mating surface, the insulating member is adapted to rotate to a position offset from the first side surface.

10. The DC socket according to claim 9, wherein the third body portion further comprises a second side surface facing the actuating member and a connecting surface located between the first side surface and the second side surface, and the first side surface is closer to the actuating member than the second side surface, and
wherein when the insulating member rotates to the position offset from the first side surface, the second elastic member drives the third body portion towards the actuating member until the connecting surface contacts the insulating member, so that the locking member locks the moving contact assembly to the switching-on position.
